(19) United States
(12) Patent Application Publication
(10) Pub. No.: US 2016/0217190 A1
(43) Pub. Date: Jul. 28, 2016

(54) SYSTEM FOR EXTRACTING RECORDS FROM A NON-RELATIONAL DATABASE BASED ON ONE OR MORE RELATIONAL DATABASE MANAGEMENT SYSTEM (RDBMS) LANGUAGE STATEMENTS

(71) Applicant: Bank of America Corporation, Charlotte, NC (US)

(72) Inventors: Thomas E. Kendrick, Frisco, TX (US); David J. Feher, Plano, TX (US); John Allen Scheel, Colorado Springs, CO (US)

(21) Appl. No.: 14/603,031

(22) Filed: Jan. 22, 2015

(51) Int. Cl. G06F 17/30

(52) U.S. Cl. CPC G06F 17/30563

(57) ABSTRACT

Disclosed are systems, methods, and computer programs for extracting records from a non-relational database based on one or more relational database management system (RDBMS) language statements. The system provides a user interface to a user and receives RDBMS language statements from the user, wherein the RBDMS language statements reference one or more files located in a non-relational database. The system identifies a copybook for each of the referenced files, where the copybook comprises data that defines a file layout for a respective file. The system associates the referenced files with the respective copybook, such that RDBMS selection criteria may reference data fields within the associated file. The system transforms the RDBMS language statements into commands and provides the commands and the one or more associated files to a Sort engine. The system receives a result set from the Sort engine and electronically present the result set to the user.

### BACKGROUND

Many entities operate with non-relational databases in their normal business productions. When such an entity desires to analyze or test the records held within these non-relational databases, the entity faces several obstacles. Currently, the entity may subset each of the files, extracting only the desired records, and creating a common format for all extracted files. However, this system requires “record-at-a-time” programming, where a user must write a unique program for each file to account for the varied record lengths and data fields of each individual file. Such a system requires an incredible amount of manual effort and can be very time consuming.

In some circumstances, the entity may have already processed these files in through a program like COBOL, where the program has created a copybook for each of the files located in the non-relational databases. These copybooks may describe the file layout for each file. Utilizing a program to associate a file from a non-relational database with its copybook may allow for automated analysis or testing of records originally held in a non-relational database. Additionally, structured query language (SQL) is a very common programming language for relational database engines while non-relational database programming languages are not as well known. Therefore, a need exists to combine the ease of writing SQL with a system that can process files located in a non-relational database.

### SUMMARY OF INVENTION

The following presents a summary of certain embodiments of the present invention. This summary is not intended to be a comprehensive overview of all contemplated embodiments, and is not intended to identify key or critical elements of all embodiments nor delineate the scope of any or all embodiments. Its sole purpose is to present certain concepts and elements of one or more embodiments in a summary form as a prelude to the more detailed description that follows.

Methods, systems, and computer program products are described herein that provide for a system for extracting records from a non-relational database based on one or more relational database management system (RDBMS) language statements. This system may generally receive, from a user, RDBMS language statements referencing one or more files located in a non-relational database; identify a copybook for each of the referenced files; transform the RDBMS language statements into commands; provide the commands and the one or more associated files to a Sort engine; receive a result set from the Sort engine; and then provide the result set to the user.

In one embodiment of the invention, a system is provided for extracting records from a non-relational database based on one or more relational database management system (RDBMS) language statements. The system comprises a computing platform comprising one or more processing devices and executable software code stored in one or more electronic storage devices, wherein the executable software code is configured to cause the one or more processing devices to provide a user interface to a user. The system may also receive RDBMS language statements from the user, wherein the RBDMS language statements reference one or more files located in a non-relational database. In some embodiments, the system may identify a copybook for each of the one or more referenced files located in the non-relational database, wherein the copybook comprises data that defines a file layout for the respective file. Furthermore, the system may associate the one or more referenced files with the respective copybook to create an associated file for each one or more referenced files, such that RDBMS selection criteria may reference data fields within the associated file. In some embodiments, the system may transform the RDBMS language statements into commands. The system may then provide the commands and the one or more associated files to a Sort engine. After the Sort engine processes the commands and associated files, the system may receive a result set from the Sort engine based on the commands and the one or more associated files provided to the Sort engine. Finally, the system may electronically present the result set to the user.

In some embodiments of the system, the executable software code configured to receiving RDBMS language statements from the user further comprises receiving SQL statements from the user.

In some embodiments of the system, the executable software code is configured to cause the one or more processing devices to provide a user interface to a user, wherein the user interface comprises a prompt template for RDBMS language statements.

In some embodiments of the system, the executable software code is configured to cause the one or more processing devices to process the one or more referenced files in a COBOL program, whereby processing the one or more referenced files in a COBOL program generates a copybook for each of the one or more referenced files.

In some embodiments of the system, the executable software code is configured to cause the one or more processing devices to provide a user interface to a user, whereby the user interface is designed to resemble a standard RDBMS user interface. In such an embodiment, the executable software code is further configured to present the result set to the user, wherein the result set substantially resembles a RDBMS result set.

In some embodiments of the system, the executable software code is configured to cause the one or more processing devices to evaluate the RDBMS language statements for spelling and syntax errors. In such an embodiment, the executable software code may further be configured to identify a spelling or syntax error and present a warning message to the user.

Another embodiment of the invention is a computer implemented method for extracting records from a non-relational database based on one or more relational database management system (RDBMS) language statements. In some embodiments, the computer implemented method comprises providing, via a processing device, a user interface to a user. In some embodiments, the computer implemented method comprises receiving, via a processing device, RDBMS language statements from the user, wherein the RBDMS language statements reference one or more files located in a non-relational database. Furthermore, in some embodiments, the computer implemented method comprises identifying, via a processing device, a copybook for each of the one or more referenced files located in the non-relational database, wherein the copybook comprises data that defines a file layout for the respective file. In some embodiments, the computer implemented method comprises associating, via a processing device, the one or more referenced files with the respective copybook to create an associated file for each one or more referenced files, such that RBDMS selection criteria may reference data fields within the associated file. In some embodiments, the computer implemented method comprises transforming, via a processing device, the RDBMS language statements into commands. Furthermore, in some embodiments, the computer implemented method comprises providing, via a processing device, the commands and the one or more associated files to a Sort engine. In some embodiments, the computer implemented method comprises receiving, via a processing device, a result set from the Sort engine based on the commands and the one or more associated files provided to the Sort engine. Finally, in some embodiments, the computer implemented method comprises electronically presenting, via a processing device, the result set to the user.

In some embodiments of the computer implemented method, the computer implemented method comprising receiving, via a processing device, RDBMS language statements from the user further comprises receiving SQL statements from the user.

In some embodiments of the computer implemented method, the computer implemented method further comprises providing, via a processing device, a user interface to a user, wherein the user interface comprises a prompt template for RDBMS language statements.

In some embodiments of the computer implemented method, the computer implemented method further comprises processing, via a processing device, the one or more referenced files in a COBOL program, whereby processing the one or more referenced files in a COBOL program generates a copybook for each of the one or more referenced files.

In some embodiments of the computer implemented method, the computer implemented method further comprises providing, via a processing device, a user interface to a user, whereby the user interface is designed to resemble a standard RDBMS user interface. In such an embodiment, the computer implemented method may further comprise presenting, via a processing device, the result set to the user, wherein the result set substantially resembles a RDBMS result set.

In some embodiments of the computer implemented method, the computer implemented method further comprises evaluating, via a processing device, the RDBMS language statements for spelling and syntax errors. In such an embodiment the computer implemented method may further comprise identifying, via a processing device, a spelling or syntax error, and subsequently presenting, via a processing device, a warning message to the user.

In another embodiment, a computer program product for acting records from a non-relational database based on one or more relational database management system (RDBMS) language statements is provided. The computer program product comprises a non-transitory computer readable medium comprising computer readable instructions. The computer readable instructions may include providing a user interface to a user. The computer readable instructions may include receiving RDMS language statements from the user, wherein the RDBMS language statements reference one or more files located in a non-relational database. Furthermore, the computer readable instructions may include identifying a copybook for each of the one or more referenced files located in the non-relational database, wherein the copybook comprises data that defines a file layout for the respective file. In some embodiments, the computer readable instructions may include associating the one or more referenced files with the respective copybook to create an associated file for each one or more referenced files, such that RDBMS selection criteria may reference data fields within the associated file. Furthermore, the computer readable instructions may include transforming the RDBMS language statements into commands. In some embodiments, the computer readable instructions may include providing the commands and the one or more associated files to a Sort engine. In some embodiments, the computer readable instructions may include receiving a result set from the Sort engine based on the commands and the one or more associated files provided to the Sort engine. Finally, the computer readable instructions may include electronically presenting the result set to the user.

In some embodiments of the computer program product, the computer readable instructions comprising receiving RDBMS language statements from the user further comprises receiving SQL statements from the user.

In some embodiments of the computer program product, the computer readable instructions comprise instructions for providing a user interface to a user, wherein the user interface comprises a prompt template for RDBMS language statements.

In some embodiments of the computer program product, the computer readable instructions comprise instructions for processing the one or more referenced files in a COBOL program, whereby processing the one or more referenced files in a COBOL program generates a copybook for each of the one or more referenced files.

In some embodiments of the computer program product, the computer readable instructions comprise instructions for providing a user interface to a user, whereby the user interface is designed to resemble a standard RDBMS user interface. In such an embodiment, the computer readable instructions may further comprise presenting the result set to the user, wherein the result set substantially resembles a RDBMS result set.

In some embodiments of the computer program product, the computer readable instructions comprise instructions for evaluating the RDBMS language statements for spelling and syntax errors. In such an embodiment, the computer readable instructions may further comprise instructions for identifying a spelling or syntax error, and subsequently presenting a warning message to the user.

To the accomplishment of the foregoing and related objectives, the embodiments of the present invention comprise the function and features hereinafter described. The following description and the referenced figures set forth a detailed description of the present invention, including certain illustrative examples of the one or more embodiments. The functions and features described herein are indicative, however, of but a few of the various ways in which the principles of the present invention may be implemented and used and, thus, this description is intended to include all such embodiments and their equivalents.

The features, functions, and advantages that have been discussed may be achieved independently in various embodiments of the invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a block diagram illustrating a system for extracting records from a non-relational database based on one or more relational database management system (RDBMS) language statements, in accordance with an embodiment of the invention;

FIG. 2 is a flow chart illustrating a system for extracting records from a non-relational database based on one or more RDBMS language statements, in accordance with an embodiment of the invention;

FIG. 3 is a sample display illustrating a user interface, in accordance with embodiments of the present invention;

FIG. 4 is a sample display illustrating a user interface, in accordance with an embodiment of the invention; and

FIG. 5 is a sample display illustrating a result set, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

Various embodiments or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The steps and/or actions of a method or algorithm described in connection with the embodiments disclosed herein may be embodied directly in hardware, in one or more software modules (also referred to herein as computer-readable code portions) executed by a processor or processing device and configured for performing certain functions, or in a combination of the two. A software module may reside in RAM memory, flash memory, ROM memory, EPROM memory, EEPROM memory, registers, a hard disk, a removable disk, a CD-ROM, or any other form of non-transitory storage medium known in the art. An exemplary storage medium may be coupled to the processing device, such that the processing device can read information from, and write information to, the storage medium. In the alternative, the storage medium may be integral to the processing device. Further, in some embodiments, the processing device and the storage medium may reside in an Application Specific Integrated Circuit (ASIC). In the alternative, the processing device and the storage medium may reside as discrete components in a computing device. Additionally, in some embodiments, the events and/or actions of a method or algorithm may reside as one or any combination or set of codes or code portions and/or instructions on a machine-readable medium and/or computer-readable medium, which may be incorporated into a computer program product.

In one or more embodiments, the functions described may be implemented in hardware, software, firmware, or any combination thereof. If implemented in software, the functions may be stored or transmitted as one or more instructions, code, or code portions on a computer-readable medium. Computer-readable media includes both non-transitory computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

In some embodiments, an “entity” may refer to a business entity that utilizes non-relational databases in its business processes, its research, or its testing procedures. For example, in some embodiments, an entity may be a financial institution, or one or more parties within the financial institution. For the purposes of this invention, a “financial institution” may be defined as any organization, entity, or the like in the business of moving, investing, or lending money, dealing with financial instruments, or providing financial services. This may include commercial banks, thrifts, federal and state savings banks, savings and loan associations, credit unions, investment companies, insurance companies, and the like. In some embodiments, an entity may maintain customer records on files within non-relational databases.

Thus, systems, methods, and computer program products are described herein that provide for a system for extracting records from a non-relational database based on one or more relational database management system (RDBMS) language statements.

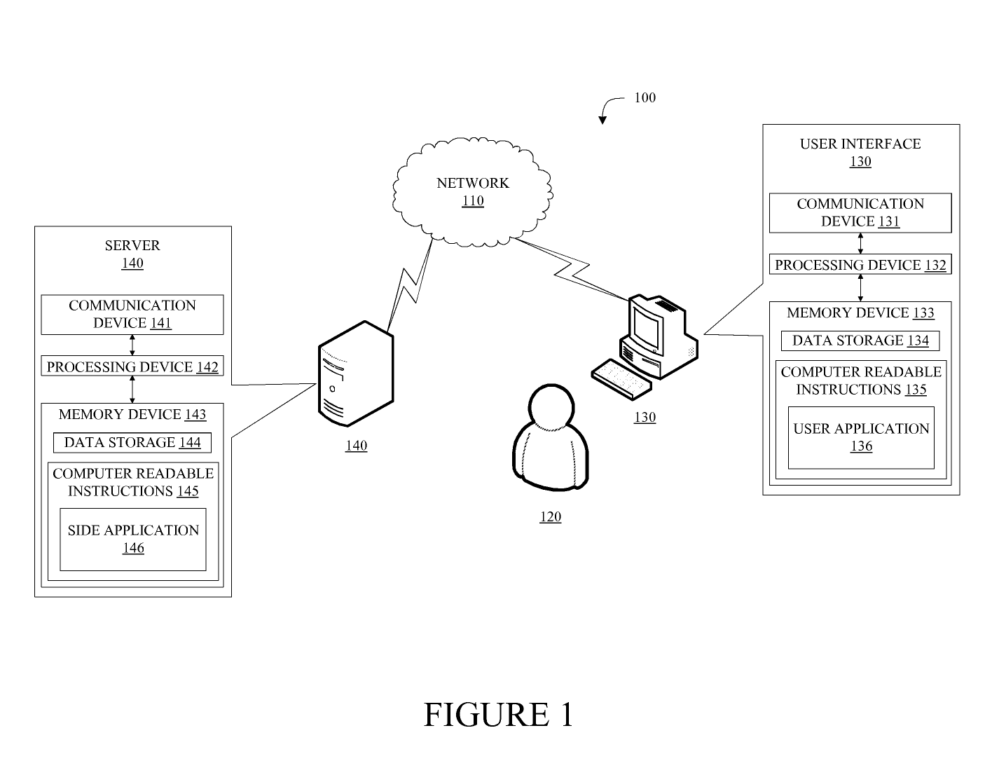

FIG. 1 illustrates an embodiment of a system 100 for manipulating files in a non-relational database into a relational configuration for RDBMS language statement processing. As illustrated, the system 100 may include a network 110 electronically connected to a user interface 130 and a server 140. A user 120 may be associated with the user interface 130 such that the user 120 may interact with the user interface 130. The server 140 may be a single server 140, or multiple servers 140 in electronic communication with each other and/or the network 110. As illustrated, the user interface 130 and the server 140 each include a communication device 131 and 141, a processing device 132 and 142, a memory storage device 133 and 143, a data storage 134 and 144, and computer readable instructions 135 and 145.

While the foregoing disclosure discusses illustrative embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any embodiment may be utilized with all or a portion of any other embodiment, unless stated otherwise. In this regard, the term “processor” and “processing device” are terms that are intended to be used interchangeably herein and features and functionality assigned to a processor or processing device of one embodiment are intended to be applicable to or utilized with all or a portion of any other embodiment, unless stated otherwise. As used with respect to the user interface 130 and server 140, a “communication device” 131 and 141 may generally include a modem, server, transceiver, and/or other device for communicating with other devices on a network. A “processing device” 132 and 142 may generally refer to a device or combination of devices having circuitry used for implementing the communication and/or logic functions of a particular system. For example, a processing device 132, 142 may include a digital signal processor device, a microprocessor device, and various analog-to-digital converters, digital-to-analog converters, and other support circuits and/or combinations of the foregoing. Control and signal processing functions of the system may be allocated between these processing devices according to their respective capabilities. The processing device may further include functionality to operate one or more programs based on computer-executable program code thereof, which may be stored in a memory device 133, 143. As the phrase is used herein, a processing device may be “configured to” perform a certain function in a variety of ways, including, for example, particular computer-executable program code embodied in computer-readable medium, and/or by having one or more application-specific circuits perform the function. The processing device 132, 142 may be configured to use the communication device 131, 141 to transmit and/or receive data and/or commands to and/or from other devices within the network 110.

A “memory device” 133, 143 may generally refer to a device or combination of devices that store one or more forms of computer-readable media for storing data and/or computer-executable program code/instructions. For example, in one embodiment, the memory device 133, 143 may include any computer memory that provides an actual or virtual space to temporarily or permanently store data and/or commands provided to the processing device 132, 142 when it carries out its functions described herein. In one embodiment, the memory device 132 of the user interface 130 includes computer readable instructions 135 that include a User Application 136, discussed more fully below. Furthermore, the memory device 142 of the server 140 includes computer readable instructions 145 that include a SQL Invoked Data Extractor (SIDE) Application 146, discussed more fully below. Additionally, in some embodiments, the memory device 133, 143 includes a data storage 134, 144 or database configured for storing information and/or data. In other embodiments, the data storage 134, 144, may be housed remotely from the user interface 130 and the server 140, and the user interface 130 and server 140 is in communication with the data storage 134, 144 across the network 110 and/or across some other communication link.

The network 110 may include a local area network (LAN), a wide area network (WAN), and/or a global area network (GAN). The network 110 may provide for wireline, wireless, or a combination of wireline and wireless communication between devices in the network. In some embodiments, the network 110 includes a wireless telephone network. In some embodiments, the network includes the Internet. In some embodiments, the network 110 includes an intranet. Furthermore, the network 110 may include a combination of an intranet and the Internet.

The User Application 136 may be any type of application capable of providing a user interface to a user 120, receiving statements or commands from a user 120, communicating with a server 140, and presenting software program results to a user 120. The SIDE Application 146 may be any application capable of identifying RDBMS language statements; evaluating RDBMS language statements for spelling and syntax; converting RDBMS language statements into commands for a Sort engine; identifying copybooks related to one or more files; associating a copybook with a respective file from a non-relational database, such that RDBMS selection criteria may reference data fields within the associated file; providing commands and associated files to a Sort engine; receiving a result set of the Sort engine; and communicating the result set to a user interface 130.

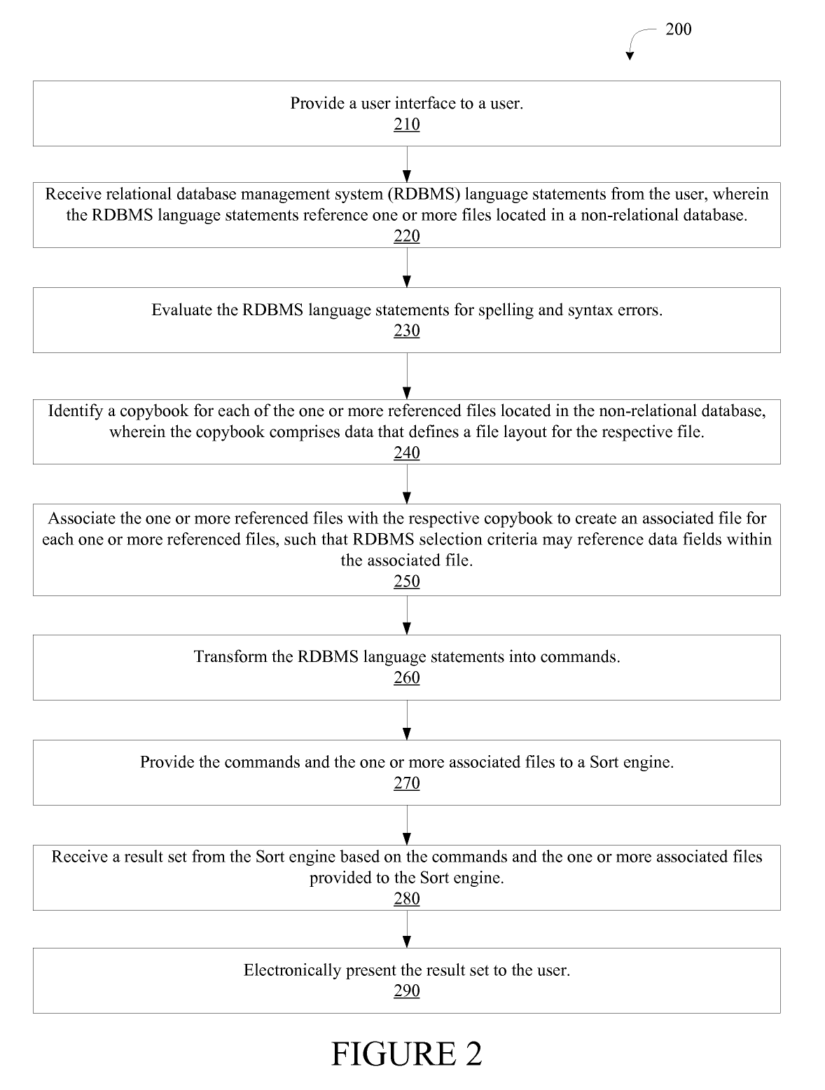

FIG. 2 is a process flow 200 of a system 100 for extracting records from a non-relational database based on one or more relational database management system (RDBMS) language statements. As illustrated by block 210, the system 100 provides a user interface to a user 120. The user interface may be presented to the user 120 via the User Application 136 on the user interface 130. In some embodiments, the user interface is a terminal interface. In some embodiments, the user interface is a command line interface (CLI). In some embodiments, the user interface allows a user to employ Interactive System Productivity Facility (ISPF) panel menus in communicating with, and/or navigating within the invention. The user interface provides a visual prompt for the user 120 to provide one or more RDBMS language statements, written in a programming language, designed to manipulate relational data with clauses, expressions, predicates, queries, and statements. In some embodiments, the user interface is provided to prompt the user 120 to respond using Structured Query Language (SQL), though other RDBMS languages may be used. In some embodiments, the user interface may comprise commands embedded within menu panels of an ISPF panel. In some embodiments, the user 120 may not perceive any difference in the user interface than when the user 120 is running a normal RDBMS, although the system 100 may be taking additional actions behind the scenes, beyond a normal RDBMS engine system. In some embodiments, the user 120 enters statements that reference one or more specific files located in one or more non-relational databases. The files may be located on either the data storage 134 of the user interface 130, or the data storage 144 of a server 140. For example, the user 120 may be writing statements in SQL, but a normal SQL engine cannot properly execute such statements when the referenced files are in a non-relational database. Therefore, aspects of this invention will transform these files and statements so that they are usable in a relational database engine environment (i.e., RDBMS selection criteria may reference data fields within the associated file). In some embodiments, the user interface is provided to prompt the user 120 to respond using the Restructured Extended Executor (REXX) language. In some embodiments of the invention, the system 100 provides a template of RDBMS language code, from which a user 120 may use to structure the RDBMS language statement.

As illustrated by block 220, the system 100 receives RDBMS language statements from the user 120, wherein the RDBMS language statements reference on or more files located in a non-relational database. In some embodiments of the invention, the system 100 may store the RDBMS language statements and the names of the files referenced in the statements within the data storage 134 of the user interface 130 or within the data storage 144 of a server 140. In some embodiments, the RDBMS language statements are stored in a separate data storage 134, 144, than the files referenced in the statements. In some embodiments, the statements and/or referenced files may be stored in such a way that the system 100 may easily pull the information at a later point in time.

As illustrated by block 230, the system 100 evaluates the RDBMS language statements for spelling and syntax errors. Since the user 120 is not writing RDBMS language statements into a normal RDBMS engine, the system 100 must provide this validation step to mimic a normal RDBMS engine and help the user 120 know whether the provided RDBMS language statements are actionable. If the system 100 determines that either the spelling or syntax is incorrect or improper, the system 100 may present an error message to the user 120 indicating the error and possibly a tip or suggestion for amending the RDBMS language statement. Once the system determines that the RDBMS language statements provided by the user 120 are actionable, no message needs to be returned to the user and the system 100 may move on to the next step. In some embodiments, the system 100 may display a confirmation message to the user 120 when the system 100 determines that there are no spelling or syntax errors in the RDBMS language statement.

As illustrated by block 240, the system 100 identifies a copybook for each of the one or more referenced files located in the non-relational database, wherein the copybook comprises data that defines a file layout for the respective file. A copybook is a separate file, or set of data, that defines the file layout for a specific file, when using the COBOL computer programming language. A file layout may provide a description and location of each record within the file. The name and/or location of the copybook may be provided by the user 120 when the user provides the statements. In another embodiment, the system 100 may derive the name and/or location of the copybook from the statements provided by the user. For example, if a user 120 provides a statement that references “File XXXX,” then the system may use this information to determine that the name of the copybook is “File XXXX_Copybook.” The system 100 may be organized such that it will always look for a copybook within a certain data storage 134 or 144, or the system 100 may determine the location of the copybook based on the input of the user 120. For example, if the user references a file as “Database1/Folder1/SubFolder2/FileXXXX,” then the system 100 may determine that the copybook is located in SubFolder2, of Folder1, of Database1. In some embodiments, the copybooks are stored in a data dictionary, a database comprising definitions of copybooks.

Most, if not all, files that are run through a COBOL program have a built-in file layout that the program saves as a copybook. Therefore, in some embodiments, the files referenced by a user must have previously been processed in some COBOL program on the system 100 at an earlier point in time. In some embodiments, an entity is utilizing the invention and has previously run the files through a COBOL program as part of its normal business activity. As such, a copybook was created for each of these files and stored in a data dictionary within a data storage 134 or 144. In some embodiments, the system 100 “freezes” the copybook and its respective file to ensure that the copybook and the file maintain the same format. Such an embodiment may allow an entity to utilize the system 100 of the invention to test and/or analyze aspects of the files, even when the files are located in non-relational databases.

As illustrated by block 250, the system 100 associates the one or more files with their respective copybook to create an associated file for each one or more referenced files, such that RDBMS selection criteria may reference data fields within the associated file. This step requires binding a referenced file with its copybook such that an engine can determine the fields structure of the referenced file. In some embodiments, the system and the engine use the copybook as a separate module to determine the fields of the referenced file. In other embodiments, the system combines the copybook and the referenced file into a new file containing both sets of data, such that an engine may determine the structure of the original referenced file and interact with its desired file contents. In either embodiment, each bounded file may be referred to as an associated file.

As illustrated by block 260, the system 100 transforms the RDBMS language statements into commands. In some embodiments, the commands are actionable by a Sort engine. In some embodiments, the RDBMS language statement is the same as the command. In other embodiments, the system 100 must transform identified RDBMS language statements received from the user 120 into a parallel command for a Sort engine such that the Sort engine will execute the same actions based on the commands as an RDBMS engine would execute on the RDBMS language statements.

As illustrated by block 270, the system 100 provides the commands and the one or more associated files to a Sort engine. This Sort engine may be any mainframe program designed to sort records in a file into a specified order, merge pre-sorted files into a sorted file, or copy selected records, based on commands. Examples of Sort engines include DFSORT (created by IBM Corp.), SyncSort® (created by Syncsort, Inc.), and CA Sort® (created by CA Technologies). In one embodiment, the Sort engine may run on an operating system, for example the z/OS operating system (produced by IBM), though other operating systems may be used. In some embodiments, a Time Sharing Option/Interactive Structured Productivity Facility (TSO/ISPF) may run under the operating system.

The Sort engine may then process the commands and the one or more associated files. In some embodiments, the Sort engine may process the commands in the foreground of the system 100. In other embodiments, the Sort engine may process the commands in the background of the system 100. In some embodiments, the Sort engine may process multiple commands in a batch job. The Sort engine may use the commands to extract the desired records (e.g., data) from the associated file, and present this desired file record information to the system 100 in the form of a result set. In some embodiments, the commands cause the Sort engine to extract specific data, or records, from the file, using the copybook as a reference as to the location of specified data within the file. For example, a command may tell the Sort engine to extract the file record pertaining to “DataField 1.” The Sort engine would then identify the reference to DataField 1 within the file's copybook, determine the location of the DataField 1 record in the actual file, and then extract that record, or set of records, from the file.

As illustrated by block 280, the system 100 receives a result set from the Sort engine based on the commands and the one or more associated files provided to the Sort engine. The system 100 may then save the result set in the data storage 144 of the server 140 or the data storage 134 of the user interface 130.

As illustrated by block 290, the system 100 electronically presents the result set to the user 120. In some embodiments, the system 100 presents the results set to the user in a format that is identical to what a RDBMS program would use. In such an embodiment, the user 120 may not perceive any difference in using a RDBMS program versus the system 100 of this invention. This may be true even though, as described above, a standard RDBMS program would not have been able to take the appropriate actions on the non-relational databases. In some embodiments, the result set is saved as a relational database for later analysis and/or manipulation by the user 120. In some embodiments, the result set provided to the system 100 by the Sort engine is in a format expected by the user. In such an embodiment, the system 100 may present the result set to the user without making changes to the format of the result set. In other embodiments, the result set provided to the system 100 by the Sort engine is in a format that is different from what the user would expect when using a normal RDBMS engine. In such an embodiment, the system 100 may re-format the result set to adhere to the expected format of RDBMS engine results.

In some embodiments of the invention, the system 100 includes a software “pull-up” that allows a user 120 to check a small batch of results before allowing the system 100 to extract the entire result set. For example, a user 120 planning to extract a result set of 1,000 files may want to make sure that the correct types of results will be extracted by the system 100 before the user 120 processes all 1,000 files, so the user 120 causes the system 100 to only produce 10 results at first, instead of the full 1,000 results. The user 120 may then check the 10 results to ensure that they conform to what the user 120 expected, before allowing the system 100 to continue extracting the full result set. In some embodiments of the invention, this is a reiterative process so the first 10 results would not be re-extracted.

In some embodiments of the invention, the system 100 provides a data dictionary editor in the presentation of a user interface to the user 120. The data dictionary editor may allow the user 120 to import a copybook from a COBOL program or database. In some embodiments, the user 120 may edit the contents of the data dictionary by adding, removing, or changing the format of the copybooks within the data dictionary. In some embodiments, the system 100 requires a user 120 to associate the data dictionary and/or one or more copybooks within the data dictionary with the RDBMS language statements of the user 120 and the files referenced in the RDBMS language statements. In some embodiments, the system 100 may allow a user 120 to import specific copybooks relevant to the referenced files in the RDBMS language statements by the user 120, and the system 100 may then provide a suggested RDBMS language statement to include in the user interface.

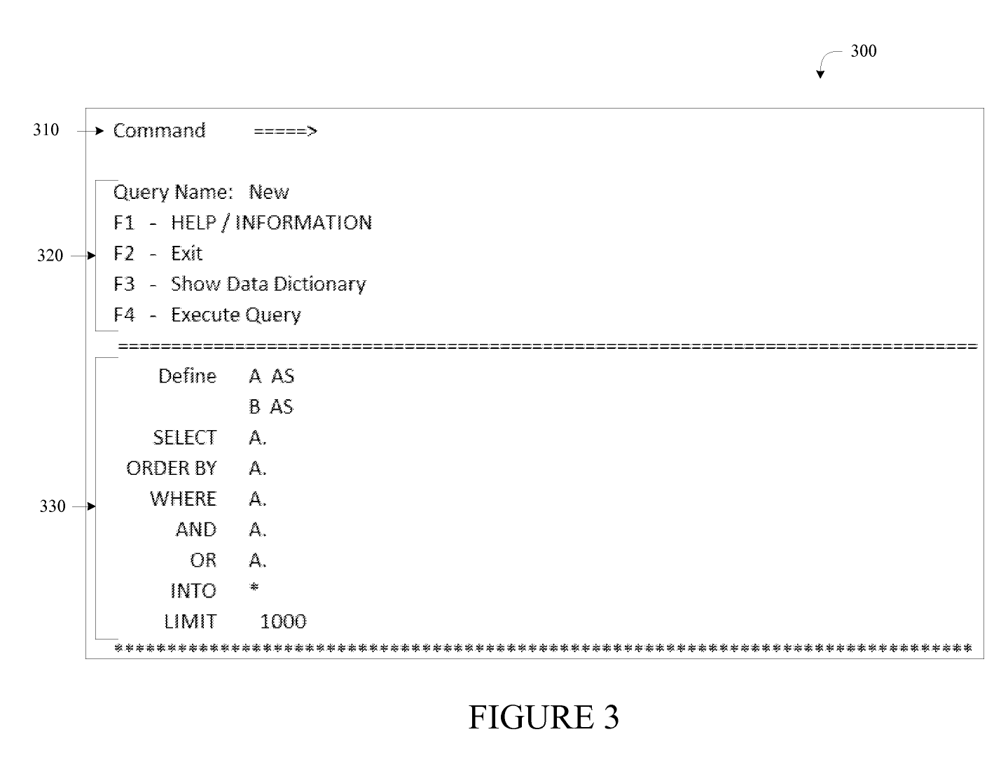

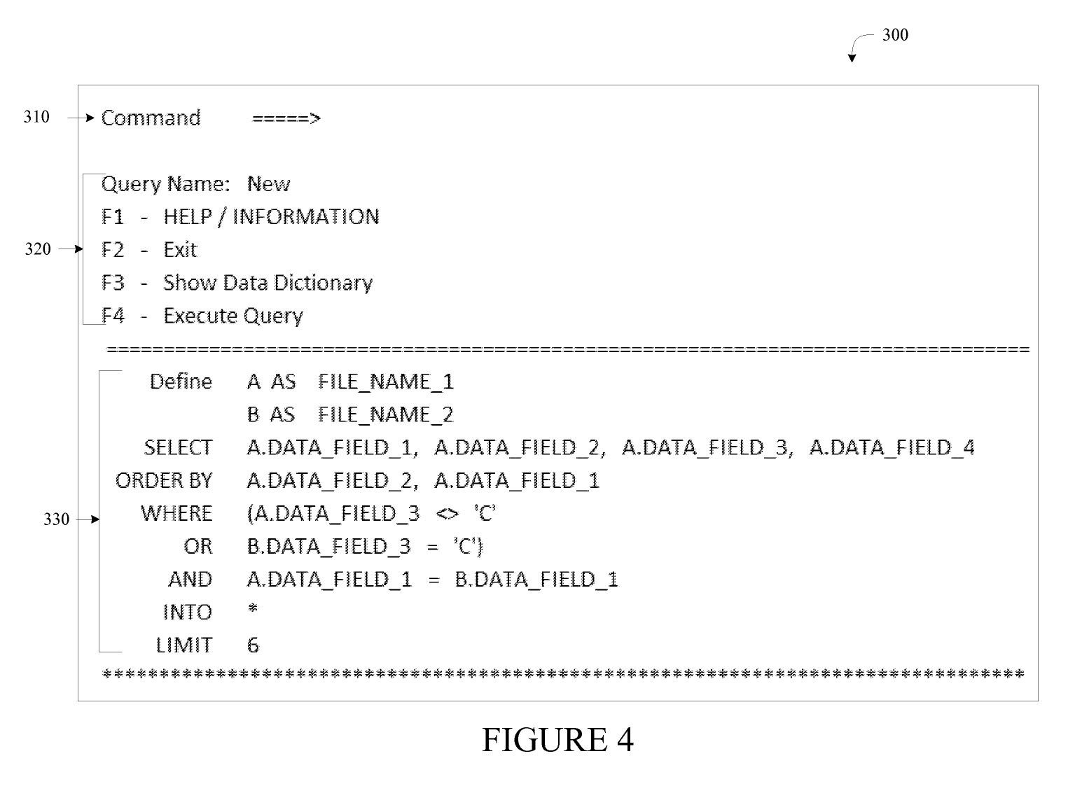

FIGS. 3-4 depict a screenshot of one embodiment of the user interface 300, as it may be displayed to the user 120. In this embodiment, the user interface 300 includes a command line 310, a menu 320, and template language 330. The command line 310 may be any tool that allows a user 120 to enter a RDBMS language statement or command. For example a user 120 using SQL may enter SQL statements in at the command line 310. The menu 320 provides hot keys for several common features of the user interface 300. These features may include “Help/Information” (i.e., provide a list of instructions, definitions, troubleshooting tips, and the like), “Exit” (i.e., exit the application), “Show Data Dictionary” (i.e., provide the data dictionary to the user 120), and “Execute Query” (i.e., submit the RDBMS language statements to the system 100). The menu 320 also provides a line for naming the query. The name of the template in FIGS. 3 and 4 is “New.” In some embodiments, the system 100 may save the template under this name, and a user 120 may provide the specific template to the user 120 when selected by the user 120 at a later point in time. While the example screenshot shown in FIGS. 3-4 illustrate a command line interface (CLI), any other user interface could be used.

FIG. 3 illustrates one embodiment of the template language 330, in the format presented to the user 120. As illustrated, the template language 330 provides several lines of standard and unfinished SQL code, though any RDBMS language may be used. As illustrated, the template may provide a the following incomplete SQL statements: “Define A AS [blank]; B AS [blank]”; “SELECT A.[blank]”; “ORDER BY A. [blank]”; “WHERE A. [blank]”; “AND A. [blank]”; “OR A. [blank]”; “INTO *”; and “LIMIT 1000.” Of course, other incomplete SQL statements may be provided, and the provided incomplete SQL statements may be altered by the user 120 to meet the demands of the user 120. For example, the user 120 may choose to limit the number of results to 6, and therefore could change the last line of the template language 330 to “LIMIT 6.” The user 120 may fill in the blanks provided with data files and/or SQL statements.

FIG. 4 illustrates one embodiment of the user interface 300, where the user 120 has either written a set of SQL statements or filled in an template language 330. As illustrated, the user entered file names in the first two rows, defining the variable “A” as “FILE_NAME_1” and variable “B” as “FILE_NAME_2.” In some embodiments, the locations of FILE_NAME_1 and FILE_NAME_2 may be in one or more non-relational databases. In some embodiments, the entity has already run FILE_NAME_1 and FILE_NAME_2 through a COBOL program as part of the entity's normal business practices, wherein the COBOL program generated a copybook for each of FILE_NAME_1 and FILE_NAME_2. The user 120 also added 4 data fields to be selected from within the two referenced files. The user 120 decided to order the data fields by the second data field, and then the first data field. The next two lines comprise a “WHERE” clause, where data field 3 of the first file is not equal to ‘C,’ OR data field 3 of the second file is equal to ‘C.’ The statement “INTO *” may be a command to return all columns in the result set. The final line of the completed template language 330, in this example, tells the system 100 that only 6 lines should be returned in the result set.

The user 120 may select the “Execute Query” hotkey (“F4” in this embodiment), and the system 100 will then continue its process steps outlined in FIG. 2. For example, the system 100 may then receive the SQL statements provided by the user 120, through the user interface 300. The system 100 may then evaluate the SQL statements for spelling and syntax errors. In some embodiments, the system 100 may detect an error in either spelling or syntax and may provide an error message to the user 120. Continuing with the example, the system 100 may then identify a copybook for each of FILE_NAME_1 and FILE_NAME_2. The system 100 may then associate each copybook with its respective file. This process may comprise combining, binding, pairing, or other method of associating the file and the copybook together so that a Sort engine may analyze each file as though it was from a relational database. The system 100 may then transform the SQL statements into one or more commands, wherein the commands may cause a Sort engine to process the two referenced files in the same manner a SQL engine would have processed the files had the files originally been in a relational database. Next, the system 100 may provide the commands and the two associated files (one for FILE_NAME_1 and one fore FILE_NAME_2) to a Sort engine. The Sort engine may then process the files, with the direction of the commands, as discussed above. The system 100 may then receive a result set from the Sort engine. In some embodiments, the system 100 may reconfigure the result set so that it is organized in the format of a SQL result set. Finally, the system 100 may present this result set to the user 120 at the user interface 130.

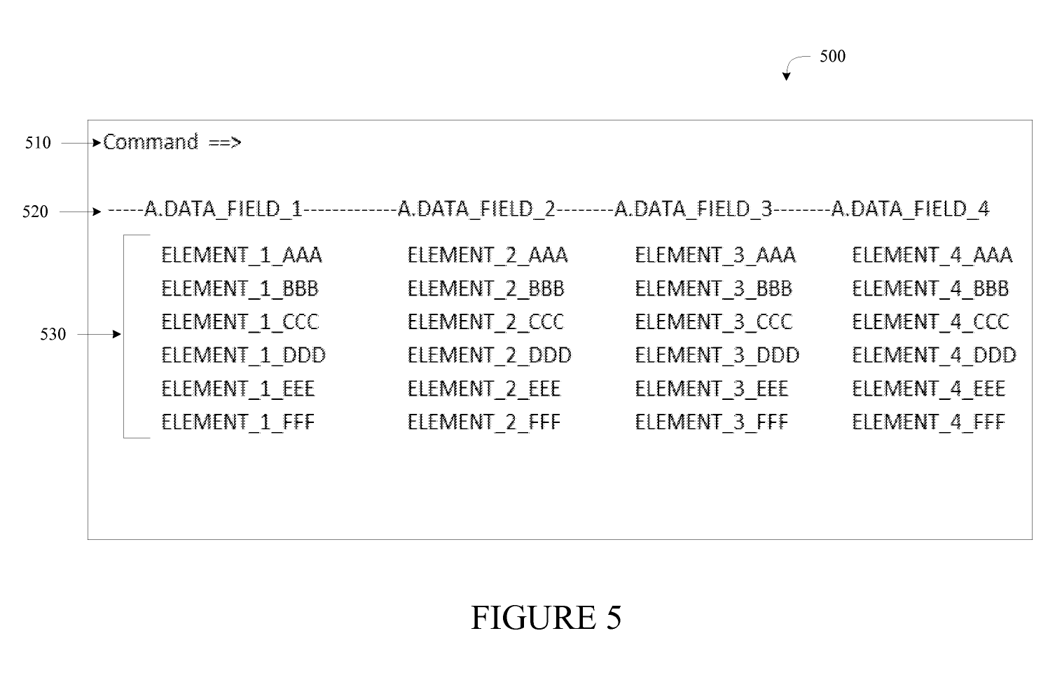

FIG. 5 illustrates a screenshot of one embodiment of the result set 500, as it may be provided to the user 120. In this embodiment, the result set 500 comprises a command line 510, a set of result columns 520, a set of results 530 organized in rows. The command line 510 may be the same type of command line 300 illustrated in FIGS. 3 and 4. The set of result columns 520, as illustrated, displays the four data fields identified by the user 120 in the user interface 300 from FIG. 4. The six rows beneath the set of result columns 520 are the set of results 530. In some embodiments, the set of results 530 are records that have been extracted from the first and second referenced files by the Sort engine. The result set 500 may provide an organized chart from which the user 120 may analyze records of the entity that were originally stored within files in a non-relational database.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for extracting records from a non-relational database based on one or more relational database management system (RDBMS) language statements, said system comprising:
a computing platform comprising one or more processing devices and executable software code stored in one or more electronic storage devices, wherein the executable software code is configured to cause the one or more processing devices to:
provide a user interface to a user;
receive RDBMS language statements from the user, wherein the RBDMS language statements reference one or more files located in a non-relational database;
identify a copybook for each of the one or more referenced files located in the non-relational database, wherein the copybook comprises data that defines a file layout for the respective file;
associate the one or more referenced files with the respective copybook to create an associated file for each one or more referenced files, such that RDBMS selection criteria may reference data fields within the associated file;
transform the RDBMS language statements into commands;
provide the commands and the one or more associated files to a Sort engine;
receive a result set from the Sort engine based on the commands and the one or more associated files provided to the Sort engine; and
electronically present the result set to the user.

2. The system of claim 1, wherein receiving RDBMS language statements from the user comprises receiving SQL statements from the user.

3. The system of claim 1, wherein the executable software code is configured to cause the one or more processing devices to provide a user interface to a user, wherein the user interface comprises a prompt template for RDBMS language statements.

4. The system of claim 1, wherein the executable software code is further configured to cause the one or more processing devices to process the one or more referenced files in a COBOL program, whereby processing the one or more referenced files in a COBOL program generates a copybook for each of the one or more referenced files.

5. The system of claim 1, wherein the executable software code is configured to cause the one or more processing devices to:
provide a user interface to a user, whereby the user interface is designed to resemble a standard RDBMS user interface; and
present the result set to the user, wherein the result set substantially resembles a RDBMS result set.

6. The system of claim 1, wherein the executable software code is configured to cause the one or more processing devices to:
evaluate the RDBMS language statements for spelling and syntax errors;
identify a spelling or syntax error; and
present a warning message to the user.

7. A computer implemented method for extracting records from a non-relational database based on one or more relational database management system (RDBMS) language statements, said computer implemented method comprising:
providing, via a processing device, a user interface to a user;
receiving, via a processing device, RDBMS language statements from the user, wherein the RBDMS language statements reference one or more files located in a non-relational database;
identifying, via a processing device, a copybook for each of the one or more referenced files located in the non-relational database, wherein the copybook comprises data that defines a file layout for the respective file;
associating, via a processing device, the one or more referenced files with the respective copybook to create an associated file for each one or more referenced files, such that RBDMS selection criteria may reference data fields within the associated file;
transforming, via a processing device, the RDBMS language statements into commands;
providing, via a processing device, the commands and the one or more associated files to a Sort engine;
receiving, via a processing device, a result set from the Sort engine based on the commands and the one or more associated files provided to the Sort engine; and
electronically presenting, via a processing device, the result set to the user.

8. The computer implemented method of claim 7, wherein receiving, via a processing device, RDBMS language statements from the user further comprises receiving SQL statements from the user.

9. The computer implemented method of claim 7, further comprising providing, via a processing device, a user interface to a user, wherein the user interface comprises a prompt template for RDBMS language statements.

10. The computer implemented method of claim 7, further comprising processing, via a processing device, the one or more referenced files in a COBOL program, whereby processing the one or more referenced files in a COBOL program generates a copybook for each of the one or more referenced files.

11. The computer implemented method of claim 7, further comprising:
providing, via a processing device, a user interface to a user, whereby the user interface is designed to resemble a standard RDBMS user interface; and
presenting, via a processing device, the result set to the user, wherein the result set substantially resembles a RDBMS result set.

12. The computer implemented method of claim 7, further comprising:
evaluating, via a processing device, the RDBMS language statements for spelling and syntax errors;
identifying, via a processing device, a spelling or syntax error; and
presenting, via a processing device, a warning message to the user.

13. A computer program product for acting records from a non-relational database based on one or more relational database management system (RDBMS) language statements, the computer program product comprising a non-transitory computer readable medium comprising computer readable instructions, the instructions comprising instructions for:
providing a user interface to a user;
receiving RDMS language statements from the user, wherein the RDBMS language statements reference one or more files located in a non-relational database;
identifying a copybook for each of the one or more referenced files located in the non-relational database, wherein the copybook comprises data that defines a file layout for the respective file;
associating the one or more referenced files with the respective copybook to create an associated file for each one or more referenced files, such that RDBMS selection criteria may reference data fields within the associated file;
transforming the RDBMS language statements into commands;
providing the commands and the one or more associated files to a Sort engine;
receiving a result set from the Sort engine based on the commands and the one or more associated files provided to the Sort engine; and
electronically presenting the result set to the user.

14. The computer program product of claim 13, wherein receiving RDBMS language statements from the user comprises receiving SQL statements from the user.

15. The computer program product of claim 13, further comprising providing a user interface to a user, wherein the user interface comprises a prompt template for RDBMS language statements.

16. The computer program product of claim 13, further comprising processing the one or more referenced files in a COBOL program, whereby processing the one or more referenced files in a COBOL program generates a copybook for each of the one or more referenced files.

17. The computer program product of claim 13, further comprising instructions for:
providing a user interface to a user, whereby the user interface is designed to resemble a standard RDBMS user interface; and
presenting the result set to the user, wherein the result set substantially resembles a RDBMS result set.

18. The computer program product of claim 13, further comprising instructions for:
evaluating the RDBMS language statements for spelling and syntax errors;
identifying a spelling or syntax error; and
presenting a warning message to the user.
